(19) United States
(12) Patent Application Publication
(10) Pub. No.: US 2011/0231194 A1
(43) Pub. Date: Sep. 22, 2011

(54) Interactive Speech Preparation

(76) Inventor: Steven Lewis, Pacific Palisades, CA (US)

(21) Appl. No.: 12/970,141

(22) Filed: Dec. 16, 2010

Related U.S. Application Data
(60) Provisional application No. 61/340,700, filed on Mar. 22, 2010.

(51) Int. Cl. G10L 21/06

(52) U.S. Cl. 704/276; 704/E21.019

(57) ABSTRACT

In an embodiment, a method of interactive speech preparation is disclosed. The method may include or comprise displaying an interactive speech application on a display device, wherein the interactive speech application has a text display window. The method may also include or comprise accessing text stored in an external storage device over a communication network, and displaying the text within the text display window while capturing video and audio data with video and audio data capturing devices, respectively.

### CROSS REFERENCE TO RELATED APPLICATIONS

This application claims the benefit of U.S. Provisional Application No. 61/340,700, filed on Mar. 22, 2010, which is incorporated herein by reference in its entirety.

### TECHNICAL FIELD

The present application relates to the field of speech preparation.

### BACKGROUND

Different forms of speech are routinely implemented by people around the world to communicate ideas to one another. In so much as human beings are relatively social creatures by nature, the act of communicating through speech is an integral part of human society. Moreover, it is oftentimes extremely important that a person be able to effectively communicate through speech in order to be successful in the business world. This is especially true in those professions that rely upon electronic communication systems, such as radio and television, to reach vast audiences over long distances. As such, speech preparation and rehearsal has become increasingly important in modern times.

### SUMMARY

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In an embodiment, a method of interactive speech preparation is disclosed. The method may include or comprise displaying an interactive speech application on a display device, wherein the interactive speech application has a text display window. The method may also include or comprise accessing text stored in an external storage device over a communication network, and displaying the text within the text display window while capturing video and audio data with video and audio data capturing devices, respectively.

Additionally, in an embodiment, an interactive speech preparation system is disclosed. The system may include or comprise a bus, a processor associated with the bus, a display device associated with the bus, video and audio data capturing devices associated with the bus, and a local storage device associated with the bus and storing a set of instructions that when executed: cause the processor to access text stored in an external storage device over a communication network, cause the display device to display an interactive speech application having a text display window, and to further display the text within the text display window, and cause the video and audio data capturing devices to capture video and audio data, respectively, when the text is displayed within the text display window.

Moreover, in an embodiment, a method of interactive speech preparation is disclosed, wherein the method may include or comprise displaying an interactive speech application on a display device, and displaying text within the interactive speech application while capturing video and audio data with video and audio data capturing devices, respectively. The method may also include or comprise generating audio and video analyses of the audio and video data, respectively, displaying the audio and video analyses within the interactive speech application, and displaying the video data within the interactive speech application while outputting the audio data with an audio output device.

### DESCRIPTION OF THE DRAWINGS

The accompanying drawings, which are incorporated in and form a part of this specification, illustrate embodiments of the present technology, and, together with the Detailed Description, serve to explain principles discussed below.

FIG. 1 is a diagram of an exemplary communication system in accordance with an embodiment.

FIG. 2 is a block diagram of a first exemplary arrangement of an interactive speech preparation system in accordance with an embodiment.

FIG. 3 is a block diagram of a second exemplary arrangement of an interactive speech preparation system in accordance with an embodiment.

FIG. 4 is a diagram of a first exemplary configuration of an interactive speech application in accordance with an embodiment.

FIG. 5 is a diagram of a second exemplary configuration of an interactive speech application in accordance with an embodiment.

FIG. 6 is a diagram of a third exemplary configuration of an interactive speech application in accordance with an embodiment.

FIG. 7 is a diagram of a fourth exemplary configuration of an interactive speech application in accordance with an embodiment.

FIG. 8 is a diagram of a fifth exemplary configuration of an interactive speech application in accordance with an embodiment.

FIG. 9 is a flowchart of a first exemplary method of interactive speech preparation in accordance with an embodiment.

FIG. 10 is a flowchart of a second exemplary method of interactive speech preparation in accordance with an embodiment.

The drawings referred to in this description are not to be understood as being drawn to scale except if specifically noted, and such drawings are only exemplary in nature.

### DETAILED DESCRIPTION

Reference will now be made in detail to embodiments of the present technology, examples of which are illustrated in the accompanying drawings. While the present technology will be described in conjunction with various embodiments, these embodiments are not intended to limit the present technology. Rather, the present technology is to be understood as encompassing various alternatives, modifications and equivalents.

Moreover, in the following Detailed Description, numerous specific details are set forth in order to provide a thorough understanding of the present technology. However, the present technology may be practiced without these specific details. In other instances, well-known methods, procedures, components, and circuits have not been described in detail so as to not unnecessarily obscure aspects of the exemplary embodiments presented herein.

Furthermore, for purposes of clarity, the terms “reciting”, “delivering”, “practicing” and “rehearsing” may be construed as being synonymous with the terms “saying” or “communicating”. Additionally, the terms “speech”, “script” and “monologue” may be construed as being synonymous with the term “text”.

### Overview

Pursuant to an exemplary scenario, in order to rehearse a speech or presentation, a user sets up a video camera and reads from a written script or video prompter. The user also hooks up the video camera to a playback device to review the recorded performance. This system and method of speech rehearsal is cumbersome, involves many manual steps, and can be relatively expensive, such as when a video prompter is utilized.

In an embodiment of the present technology, however, an interactive speech application is presented, wherein the interactive speech application is configured to run, for example, on a front camera equipped computer or tablet device. To illustrate, interactive speech application may be configured to display an amount of text, such as a script or speech, on a display device while capturing video and audio data of a user reciting the text. In this manner, various embodiments discussed herein may be implemented to enable a device to function as an interactive speech preparation and rehearsal system, whereby a performance is recorded while a script is being displayed to the user. The user may then review the performance so as to assess any strengths and weaknesses therein. Moreover, this system of speech preparation and rehearsal is relatively user-friendly and economical.

In particular, an embodiment provides an interactive speech preparation system that simplifies the process of practicing various forms of visual communications, such as by eliminating the implementation of a separate camera set up and complicated downloads in preparation for, or during, a recording session. It is less expensive than professional speech rehearsal systems and offers an immediate, practical use of, for example, tablet computing systems with front-mounted webcams. It is a portable, private and effective means for improving a person's personal presentation skills by enabling users to see themselves deliver their respective speeches or monologues.

It is noted that various methods of interactive speech preparation may be implemented, and that the present technology is not limited to any particular methodology. For example, in one embodiment, an interactive speech application is stored externally in a remote database or storage device. When a user registers an account with a gateway application, such as a published website, the user is able to download a copy of the interactive speech application to a local computer system. The user is also able to upload or e-mail text to an external server such that the text is stored remotely. In this manner, the interactive speech application may be saved and launched locally, while the text to be displayed in the application is accessed from a remote location.

When the text is accessed and displayed to a user by the local computer system, video and audio data of the user reciting the text are simultaneously captured, such as with a front-mounted video camera and microphone, respectively. The captured data may then be stored, either automatically or in response to a user selection. For example, this data may be stored locally, or it may be forwarded to an external server and stored remotely. Once stored, the video and audio data may be subsequently accessed and reviewed, such as by the user at the local computer system, or by a critic or trainer at a remote computer system. This review process will enable the reviewing party to help identify strengths and weaknesses in the captured performance.

The foregoing notwithstanding, it is noted that an interactive speech application, such as described herein, may be implemented as a web-based learning tool. To illustrate, and in accordance with an embodiment, an interactive speech application is implemented as a web-based, interactive speech preparation and rehearsal system that offers a subscriber access to video tutorial information pertaining to effective speaking and allows the participants to record and review their performances. The interactive speech application may optionally include a series of free and fee based training levels that range from submission of written text and video presentations for review, to one-on-one, private on line coaching provided by a staff of speech writing specialists.

Various exemplary embodiments of the present technology will now be discussed. It is noted, however, that the present technology is not limited to these exemplary embodiments, and that the present technology also includes obvious variations of the exemplary embodiments and implementations described herein. It is further noted that various well-known components are generally not illustrated in the drawings so as to not unnecessarily obscure various principles discussed herein, but that such well-known components may be implemented by those skilled in the art to practice various embodiments of the present technology.

### Exemplary Systems and Configurations

Various exemplary systems and configurations for implementing various embodiments of the present technology will now be described. However, the present technology is not limited to these exemplary systems and configurations. Indeed, other systems and configurations may also be implemented.

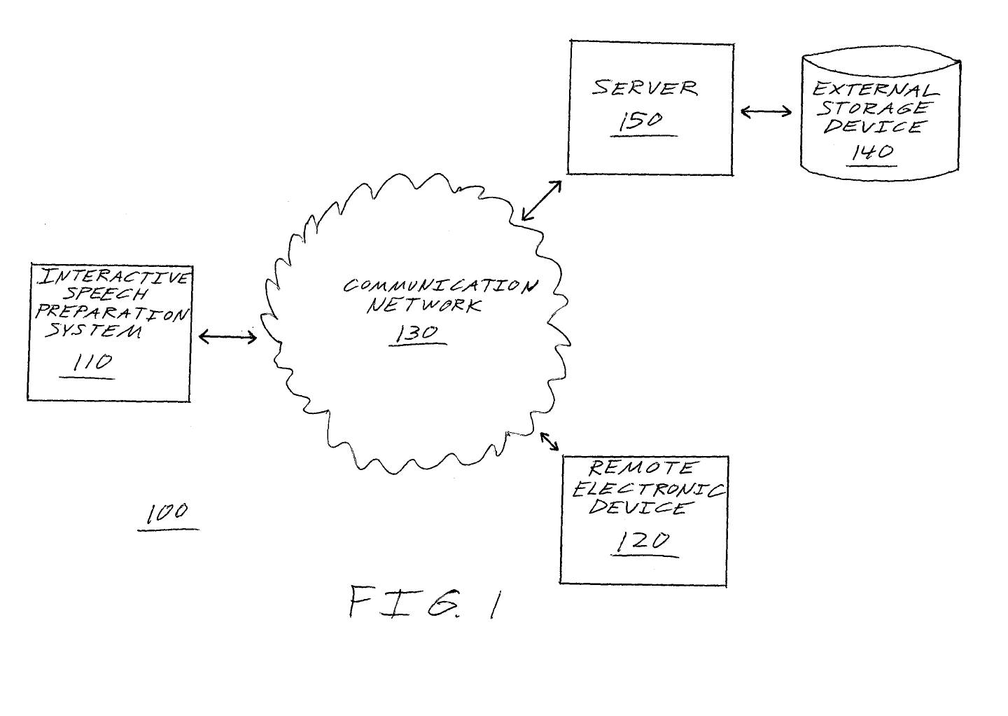

With reference now to FIG. 1, an exemplary communication system 100 in accordance with an embodiment is shown. In particular, exemplary communication system 100 includes an interactive speech preparation system 110 configured to communicate with a remote electronic device 120 over a communication network 130. Communications between interactive speech preparation system 110 and remote electronic device 120 over communication network 130 may include wireless and/or wireline communications, and communication network 130 may be any type of network capable of communicating data between interactive speech preparation system 110 and remote electronic device 120, such as a cellular network, a public switched telephone network (“PSTN”), an Internet network, or an Intranet network.

Consider the example where interactive speech preparation system 110 is a portable or handheld device integrated with a video camera and a microphone. Interactive speech preparation system 110 captures both audio and video data and forwards the captured data, in real time, to remote electronic device 120, which may also be a portable or handheld device, over a cellular network. Once the data is received, the data may be output to a user of remote electronic device 120 by means of a display screen and speakers integrated with remote electronic device 120.

With reference still to FIG. 1, interactive speech preparation system 110 is also configured to forward a request for information stored in an external storage device 140 to a server 150. Server 150 is configured to access and forward the requested information, in response to the information request, to interactive speech preparation system 110 over communication network 130. Furthermore, in accordance with one exemplary implementation, interactive speech preparation system 110 is configured to upload information to external storage device 140 by forwarding the information to server 150, such as in an e-mail, text message or an electronic file attachment, whereby server 150 will store the information in external storage device 140.

In one embodiment, interactive speech preparation system 110 is configured to store and/or launch an interactive speech application, which is in turn configured to perform various embodiments of the present technology. In this regard, it is noted that a method as disclosed herein, or a portion thereof, may be executed using a computer system. Indeed, in accordance with one embodiment, instructions are stored on a computer-readable medium, wherein the instructions when executed cause a computer system or data processor to perform a particular method, or a portion thereof, such as disclosed herein. As such, reference will now be made to a number of exemplary computer system environments, wherein such environments are configured to be adapted so as to store and/or execute a set of computer-executable instructions. However, other computer system environments may also be implemented.

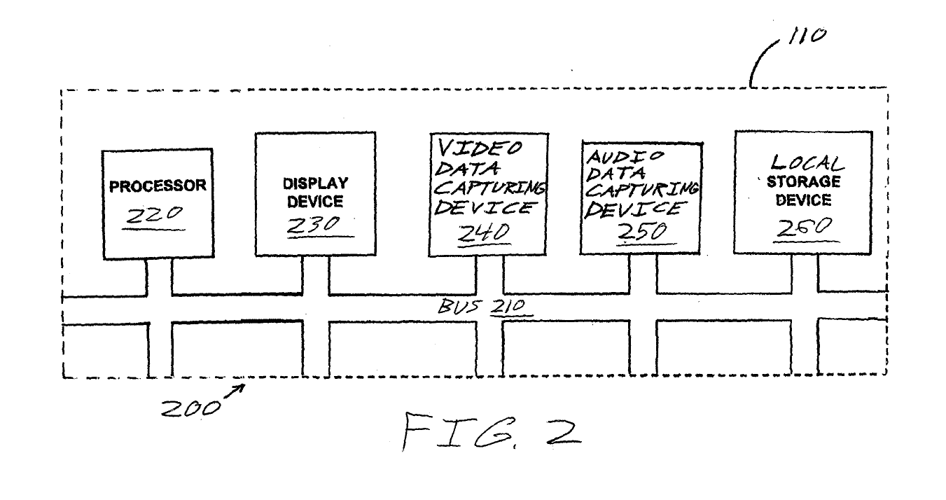

With reference now to FIG. 2, a first exemplary arrangement 200 of interactive speech preparation system 110 in accordance with an embodiment is shown. In particular, interactive speech preparation system 110 is configured to perform calculations, processes, operations, and/or functions associated with a program or algorithm. In one embodiment, certain processes and steps discussed herein are realized as a series of instructions (e.g., a software program) that reside within one or more computer readable memory units and are executed by one or more processors of interactive speech preparation system 110. When executed, the instructions cause interactive speech preparation system 110 to perform specific actions and exhibit specific behavior, such as described herein.

With reference still to FIG. 2, interactive speech preparation system 110 includes a bus 210 (e.g., an address/data bus) that is configured to communicate information between various components of interactive speech preparation system 110. Additionally, one or more data processing units, such as processor 220, are coupled or associated with bus 210. It is noted that processor 220 is configured to process information and instructions, such as computer-readable instructions communicated to processor 220 via bus 210. It is further noted that, in accordance with one embodiment, processor 220 is a microprocessor. However, the present technology is not limited to the use of a microprocessor. Indeed, other types of processors may be implemented.

In an embodiment, interactive speech preparation system 110 also includes a display device 230 coupled or associated with bus 210, wherein display device 230 is configured to display characters, images, video and/or graphics. Display device 230 may include, for example, a cathode ray tube (“CRT”) display, a liquid crystal display (“LCD”), a light emitting diode (“LED”) display, a field emission display (“FED”), a plasma display, or any other type of display device suitable for displaying video, graphic images and/or alphanumeric characters recognizable to a user. However, the present technology is not limited to the implementation of any particular type of display device.

With reference still to FIG. 2, interactive speech preparation system 110 further includes video and audio data capturing devices 240, 250 coupled or associated with bus 210. Video data capturing device 240 is configured to capture video data, and may include, for example, a digital or analog camera capable of capturing a series of images as an image sequence. Audio data capturing device 250 is configured to capture audio data, and may include, for example, a microphone capable of detecting and translating sound waves into electric signals, wherein the generated electric signals are representative (such as in terms of signal amplitude and frequency) of the detected sound waves.

In addition to the foregoing, interactive speech preparation system 110 is configured to utilize one or more data storage units. To illustrate, and with reference still the embodiment illustrated in FIG. 2, interactive speech preparation system 110 includes a local storage device 260 coupled or associated with bus 210. Local storage device 260 may include, for example, a volatile memory unit (e.g., random access memory (“RAM”), static RAM, dynamic RAM, etc.) or a non-volatile memory unit (e.g., read-only memory (“ROM”), programmable ROM (“PROM”), erasable programmable ROM (“EPROM”), electrically erasable programmable ROM (“EEPROM”), flash memory, etc.), wherein local storage device 260 is configured to store information or instructions for processor 220. Furthermore, in one embodiment, local storage device 260 includes a magnetic or optical disk drive, such as a hard disk drive (“HDD”), a floppy diskette drive, a compact disk ROM (“CD-ROM”) drive, or a digital versatile disk (“DVD”) drive.

Pursuant to an exemplary implementation, local storage device 260 stores a set of instructions that when executed by processor 220 cause display device 230 to display an interactive speech application having a text display window therein, as well as an amount of text within the text display window. This text may be stored, for example, locally (whether in local storage device 260 or otherwise) or it may be accessed from an external storage device over a communication network. Furthermore, the set of instructions, when executed by processor 220, cause video and audio data capturing devices 240, 250 to capture video and audio data, respectively.

In view of the foregoing, an embodiment provides that interactive speech preparation system 110 is configured to display a speech to a user while simultaneously capturing video and audio data of the user saying, reciting or rehearsing the displayed speech. Indeed, in one embodiment, this data may be stored and then subsequently reviewed. In this manner, the captured data may be subsequently analyzed and scrutinized, such as to identify strengths and weaknesses in the speech and/or in the user's deliverance thereof.

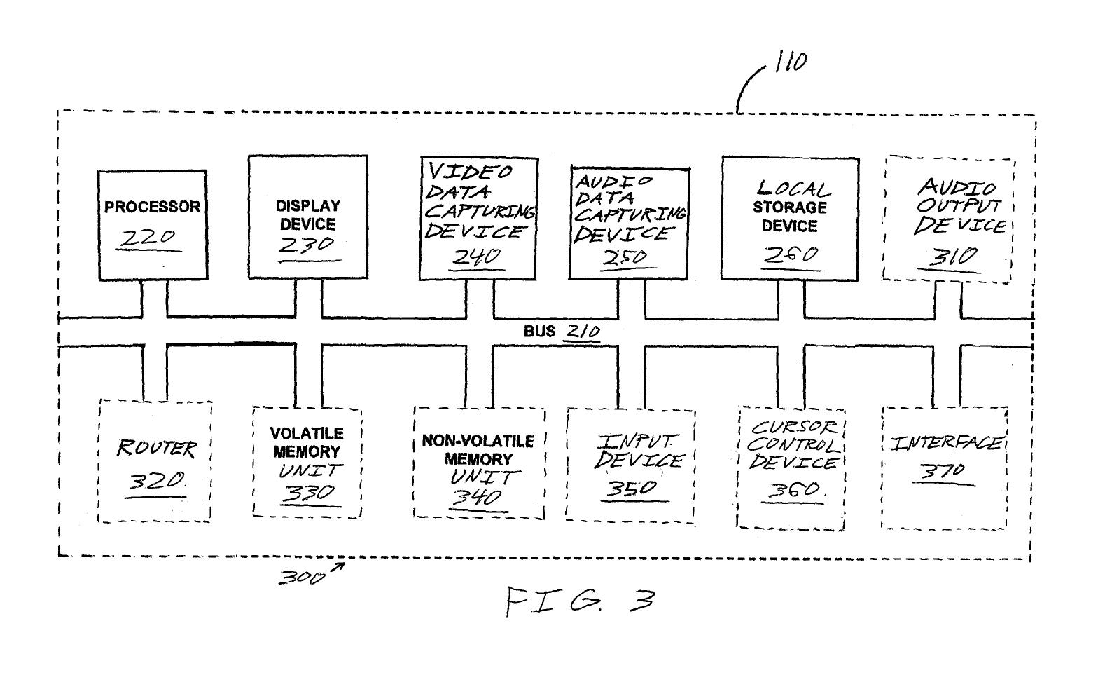

With reference now to FIG. 3, a second exemplary arrangement 300 of interactive speech preparation system 110 in accordance with an embodiment is shown. In particular, interactive speech preparation system 110 includes a number of components described above with respect to FIG. 2, as well as one or more optional components.

To illustrate, an embodiment provides that interactive speech preparation system 110 includes an audio output device 310. Audio output device 310 may include, for example, an audio speaker capable of translating an electric signal into an audible sound signal. Indeed, one exemplary implementation provides that local storage device 260 stores a set of instructions that, when executed by processor 220, causes display device 230 to display an interactive speech application having text and video display windows therein, causes display device 230 to display the video data within the video display window, and causes the audio output device to output the audio data when the video data is displayed within the video display window. In this manner, interactive speech preparation system 110 may be utilized to both capture and play back both video and audio data, such as video and audio data that detail a recorded speech rehearsal or performance, thus enabling a user to review the rehearsal or performance.

Moreover, in one embodiment, interactive speech preparation system 110 includes a router 320 coupled or associated with bus 210. With reference again to FIG. 1, router 320 is configured to communicate with remote electronic device 120 over communication network 130. Indeed, one exemplary implementation provides that local storage device 260 stores a set of instructions that when executed by processor 220 cause router 320 to initiate a video conference between remote electronic device 120 and an interactive speech application running on interactive speech preparation system 110. Additionally, the set of instructions, when executed by processor 220, cause router 320 to send, in real time, specific video and audio data to remote electronic device 120 while the video and audio data is respectively captured with video and audio data capturing devices 240, 250.

Thus, an embodiment provides a means of enabling a user of interactive speech preparation system 110 to practice or rehearse a speech while a user of remote electronic device 120 watches and listens to the rehearsal in real time. As a result, the remote user may be able to offer opinions and feedback as to, for example, the quality of the speech itself and/or the witnessed recitation or deliverance thereof.

With reference still to FIG. 3, interactive speech preparation system 110 may include a number of additional data storage devices, such as a volatile memory unit 330 (e.g., RAM, static RAM, dynamic RAM, etc.) coupled or associated with bus 210, wherein volatile memory unit 330 is configured to store information and instructions for processor 220. Alternatively, or in addition to the foregoing, interactive speech preparation system 110 may include a non-volatile memory unit 340 (e.g., ROM, PROM, EPROM, EEPROM, flash memory, etc.) coupled or associated with bus 210, wherein non-volatile memory unit 340 is configured to store static information and instructions for processor 220.

In an embodiment, interactive speech preparation system 110 includes an input device 350 coupled or associated with bus 210, wherein input device 350 is configured to communicate information and command selections to processor 220. In accordance with one exemplary configuration, input device 350 is an alphanumeric input device, such as a keyboard, that includes alphanumeric and/or function keys. Alternatively, or in addition to the foregoing, input device 350 may include a device other than an alphanumeric input device.

Pursuant to one embodiment, interactive speech preparation system 110 includes a cursor control device 360 coupled or associated with bus 210, wherein cursor control device 360 is configured to communicate user input information and/or command selections to processor 220. Moreover, an exemplary configuration provides that cursor control device 360 is implemented using a device such as a mouse, a track-ball, a track-pad, an optical tracking device, or a touch screen.

The foregoing notwithstanding, in an embodiment, cursor control device 360 is directed and/or activated via input from input device 350, such as in response to the use of special keys and/or key sequence commands associated with input device 350. In one embodiment, however, cursor control device 360 is configured to be directed or guided by voice commands.

With reference still to FIG. 3, in an embodiment, first exemplary interactive speech preparation system 110 includes one or more interfaces, such as interface 370, coupled or associated with bus 210. The one or more interfaces are configured to enable interactive speech preparation system 110 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

Indeed, it is noted that interface 370 may include or be integrated with an antenna such that interactive speech preparation system 110 is capable of communicating wirelessly (e.g., over a cellular network). In one embodiment, however, interface 370 includes or is integrated with a wireline interface, such as to communicate data through an Ethernet connector and over the Internet.

Interactive speech preparation system 110 is presented herein as an exemplary computing environment in accordance with an embodiment. However, interactive speech preparation system 110 is not strictly limited to being a computer system. For example, an embodiment provides that interactive speech preparation system 110 represents a type of data processing plan or configuration that may be used in accordance with various embodiments described herein. Moreover, other computing systems may also be implemented. Indeed, the present technology is not limited to any single data processing environment.

Thus, in an embodiment, one or more operations of various embodiments of the present technology are controlled or implemented using computer-executable instructions, such as program modules, being executed by a computer. In one exemplary implementation, such program modules include routines, programs, objects, components and/or data structures that are configured to perform particular tasks or implement particular abstract data types.

In addition, an embodiment provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

Furthermore, in one embodiment, interactive speech preparation system 110 is a portable or handheld electronic device. Such a compact design provides the advantage of enabling a user to more easily prepare, practice or rehearse speeches, such as when traveling. To illustrate, an exemplary implementation provides that interactive speech preparation system 110 is configured to allow a user to upload a script of a presentation and practice delivering the presentation by recording a video of his or her performance, such as with a front-mounted webcam enabled computer, tablet or mobile device. Indeed, an interactive speech application, such as described herein, may be run by a system operating system (“OS”), such as, for instance: Windows 7 Mobile OS™, Palm OS™, Mac OS™, Android OS™ or Blackberry OS™. However, the present technology is not limited to the implementation of a portable or handheld device.

### Exemplary Applications

As discussed above, an embodiment provides that interactive speech preparation system 110 is configured to launch and/or an interactive speech application. As such, reference will now be made to a number of exemplary configurations for an interactive speech application. It is noted, however, that the present technology is not limited to these exemplary configurations, and that other configurations for an interactive speech application may also be implemented.

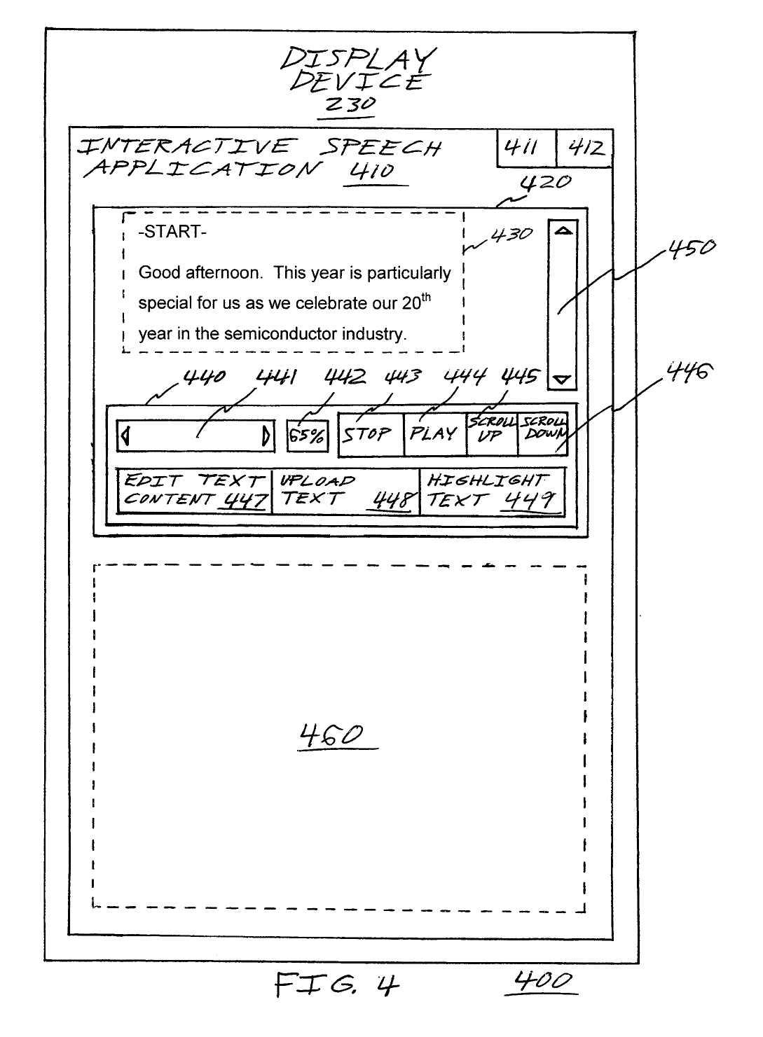

With reference now to FIG. 4, a first exemplary configuration 400 of an interactive speech application 410 in accordance with an embodiment is shown. In particular, interactive speech application 410 is displayed by display device 230, and may optionally include a number of tabs, such as tabs 411, 412, for toggling between different pages of information associated with interactive speech application 410. However, the present technology is not limited to the implementation of any particular number of pages.

Additionally, a text display window 420 is displayed within interactive speech application 410, wherein an amount of text 430, such as an uploaded speech, may be accessed and displayed within text display window 420. Furthermore, in accordance with an exemplary implementation, text 430 may be scrolled through text display window 420, such as when the dimensions of a displayed speech (based on a selected font size) are greater than the dimensions of the display area of text display window 420.

In one embodiment, text 430 is accessed from an external storage device over a communication network. For example, and with reference again to FIG. 1, text 430 may be initially uploaded to external storage device 140, such as in an e-mail, text message or an electronic file attachment, where text 430 will be stored remotely. Subsequently, server 150 accesses text 430 in external storage device 140 and forwards text 430 to interactive speech preparation system 110 over communication network 130. Next, interactive speech application 410, which is executed or run by interactive speech preparation system 110, accesses and displays text 430 within text display window 420.

The foregoing notwithstanding, it is noted that text 430 may be accessed locally, such as with voice dictation, image recognition or direct typing. To illustrate, and with reference again to FIG. 2, one embodiment provides that audio data capturing device 250 is implemented to access text 430. For example, when a user speaks, audio data capturing device 250 is utilized to capture the spoken audio data. Voice recognition software is then implemented to translate the captured audio data into text 430, which is displayed within text display window 420. Thus, in accordance with an embodiment, text 430 may be accessed locally by using, for example, an audio microphone and voice recognition technology.

Similarly, in an embodiment, video data capturing device 250 is implemented to access text 430. Consider the example where video data capturing device 250 is utilized to capture video images of a user, who may be hearing impaired, making certain physical gestures (e.g., sign language). These captured images are compared to images stored in a knowledge database, wherein the stored images are each associated with specific words or phrases, so as to translate the captured video data into text 430. Thus, pursuant to one embodiment, text 430 may be accessed locally by using, for example, a video camera and image recognition technology.

Moreover, and with reference again to FIG. 3, an embodiment provides that input device 350 includes a keyboard, or other user interface, configured to enable a user to manually type or input text 430 such that text 430 may be accessed locally rather than being downloaded over an external communications network. Alternatively, or in addition to the foregoing, a virtual keyboard may be displayed by display device 230 such that a user is able to input text 430 by touching or interacting with display device 230. Furthermore, in one embodiment, an external keyboard or input device may be plugged into or integrated with interface 370 such that a user is able to manually input text 430 through interface 370. In view of the foregoing, it is noted that a number of embodiments provide that virtual and/or physical keyboards, which may be installed within interactive speech preparation system 110 (or integrated with interactive speech preparation system 110 via a system adapter), may be implemented to acquire text 430.

With reference still to FIG. 4, in an embodiment, interactive speech application 410 is stored externally in a remote database or storage device, and when a user registers an account with a gateway application (not shown), such as a published website, the user is permitted to download a copy of the interactive speech application to a local computer system. Additionally, as a result of having registered the account, the user is also permitted to send, upload or e-mail text to an external server such that the text is stored remotely. In this manner, unauthorized access to interactive speech application 410, as well as to valuable remote storage space, may be controlled.

To further illustrate, consider the example where a user downloads the interactive speech application from a remote location and registers with a gateway application for a secure account. Once the account registration is confirmed, the user is given access to a private electronic mailbox and sends or e-mails a script, such as by means of either a .doc or .pdf file attachment, to the private mailbox. The user also activates the interactive speech application, accesses his or her text, and records a video of the user delivering the selected speech for practice and review. It is noted that the recorded data may be saved, such as a QuickTime or Flash file that is stored on the user's computer, tablet or mobile device. The video file can then be sent or e-mailed to friends, coworkers or training professionals for review and comments.

The foregoing notwithstanding, it is noted that the present technology is not limited to the aforementioned communication paradigm for accessing text 430. For example, text 430 may be stored in a local storage device, and then accessed by interactive speech application 410 from the local storage device, such as over a local data bus.

It is further noted that a number of functions may be provided so as to allow a user to control a display of information within text display window 420. To illustrate, and with reference still to FIG. 4, an embodiment provides that interactive speech application 410 includes a control panel 440, which may be positioned either within text display window 420, as shown, or alternatively outside of text display window 420. Control panel 440 includes a number of features, such as those features described herein, and represents a portion of a graphical user interface with which a user may interact to manually govern the type of information that is displayed and/or how such information is displayed within text display window 420.

For example, in one embodiment, control panel 440 includes a speed controller 441, whereby a user can manually control (e.g., by clicking on speed controller 441) the speed at which text 430 is scrolled through text display window 420. Moreover, control panel 440 may include a speed indicator 442 configured to indicate a speed with which text 430 is being scrolled through text display window 420. For purposes of illustration, and with reference to the embodiment shown in FIG. 4, text 430 is being scrolled through text display window 420 at a speed that is 65% of the maximum text scrolling speed associated with interactive speech application 410. However, in accordance with an exemplary implantation, a user may reduce or increase this scrolling speed by clicking on speed controller 441, at which time interactive speech application 410 will automatically update speed indicator 442 to reflect the newly selected speed.

Additionally, in one embodiment, control panel 440 includes a stop button 443, whereby a user, by clicking on stop button 443, can manually stop the scrolling of text 430 through text display window 420. Similarly, control panel 440 may include a play button 444, whereby a user, by clicking on play button 444, can manually initiate the scrolling of text 430 through text display window 420.

Moreover, in accordance with an embodiment, control panel 440 includes scroll up and/or scroll down buttons 445, 446, whereby a user can manually cause text 430 to scroll up and down through text display window 420 by clicking on scroll up and scroll down buttons 445, 446, respectively. Similarly, a scroll bar 450 may be provided, such as within text display window 420, whereby a user can manually cause text 430 to scroll up or down through text display window 420 by clicking on scroll bar 450.

Thus, it is noted that the present technology may be implemented such that text 430 is automatically or manually scrolled through text display window 420. Indeed, pursuant to one exemplary implementation, text 430 is automatically scrolled through text display window 420 based on a preselected scrolling speed, and this automatically scrolling is halted when a user clicks on either scroll up button 445, scroll down button 446 or scroll bar 450. At this point, interactive speech application 410 will scroll text 430 through text display window 420 based on the user's commands. However, once the user clicks on play button 444, the automatic scrolling will resume.

With reference still to FIG. 4, in an embodiment, control panel 440 includes a text editing button 447, whereby a user can manually edit text 430 by clicking on text editing button 447. Consider the example where text 430 is displayed within text display window 420. A user it able to click on text editing button 447 to cause text 430 to become editable within text display window 420, or within an additional pop-up window (not shown). In this manner, the user is able to edit a speech on the fly during speech rehearsals.

The foregoing notwithstanding, in one embodiment, control panel 440 includes a text uploading button 448, whereby a user, by clicking on text uploading button 448, can cause interactive speech application 410 to upload certain text, such as text 430, to a storage device. To illustrate, and with reference again to FIG. 1, an example provides that text 430 is displayed within text display window 420, at which time a user clicks on text uploading button 448. As a result, text 430 is sent to server 150 over communication network 130, which then stores text 430 in external storage device 140. Once stored, interactive speech application 410 may subsequently download text 430 from external storage device 140 over communication network 130.

In view of the foregoing, an embodiment provides that text editing button 447 enables a user to edit text 430 on the fly, while text uploading button 448 enables the user to upload the edited text to a storage device such that the edited text may be subsequently accessed and reviewed at a later time. In accordance with one embodiment, however, clicking on text uploading button 448 prompts a user, such as with a file menu (not shown), to upload text not currently displayed in text display window 420.

Furthermore, in an embodiment, control panel 440 includes a text highlighting button 449, whereby a user, by clicking on text highlighting button 449, can cause interactive speech application 410 to highlight certain text displayed within text display window 420. Consider the example where text 430 is scrolled through text display window 420 at a preselected scrolling speed. Adjacent words within text 430 are consecutively highlighted at a preselected highlighting speed, which is associated with the preselected scrolling speed, so as to more effectively communicate to a user where the user should be looking within text 430 when reciting words within text 430. In this manner, interactive speech application 410 may be implemented as a training application so as to train a user to recite the text at a particular rate of speed, which can help slow speakers to speed up and fast speakers to slow down.

In a second example, interactive speech application 410 is integrated with voice recognition functionality, whereby interactive speech application 410 is capable of analyzing audio data in real time while the audio data is being captured, and identifying two words associated with both of the displayed text and the captured audio data. Interactive speech application 410 then calculates a relationship between the two words within the text, and selects a scrolling speed based on the relationship. The text may then be moved within text display window 420 based on this scrolling speed.

To illustrate, it is noted that the words “Good” and “year” are included within text 430 in FIG. 4, although they are not directly adjacent to one another. If interactive speech application 410 identifies these same two words within the captured audio data, interactive speech application 410 measures the distance between these two words within text 430, such as by counting the number of characters, syllables or words located between these two words within text 430. Interactive speech application 410 is then able to calculate, based on the aforementioned measurement, a temporal relationship between the two words in the audio data to determine how fast a user is speaking. Next, interactive speech application 410 is able to select a scrolling speed based on this temporal relationship such that the selected scrolling speed is reflective of the user's natural speaking speed. In this manner, interactive speech application 410 is able to utilize speech recognition technology to automatically adjust the application's scrolling speed so as to automatically tailor the scrolling speed of the displayed text on the fly based on the speed with which the user naturally speaks.

In view of the foregoing, it is noted that, in accordance with the embodiment shown in FIG. 4, interactive speech application 410 includes at least one display window (e.g., text display window 420). However, interactive speech application 410 may optionally display a number of additional display windows (such as a second display window 460) in addition to text display window 420. Indeed, interactive speech application 410 may be configured to display two or more display windows either simultaneously or consecutively. Furthermore, interactive speech application 410 may be configured to display two or more display windows on different pages of interactive speech application 410, which may be accessed, for example, by clicking on a tab from among tabs 411, 412. However, the present technology is not limited to the display of any particular number of display windows, nor to the implementation of any number of pages.

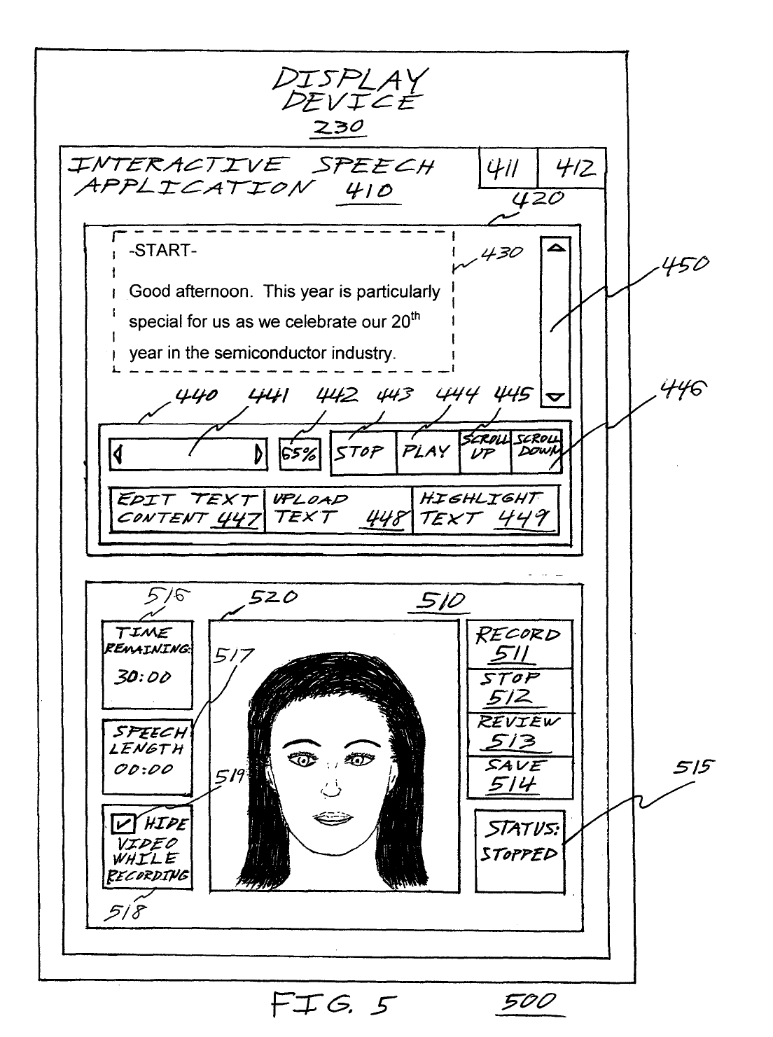

With reference now to FIG. 5, a second exemplary configuration 500 of interactive speech application 410 in accordance with an embodiment is shown. In particular, interactive speech application 410, which is displayed by display device 230, includes text display window 420 as well as a video display window 510. Video display window 510 is configured to display video images within a video display area 520 of video display window 510, such as captured video images of a user who is currently or has recently recited text displayed in text display window 420.

To illustrate, an example provides that a video data capturing device, such as video data capturing device 240 in FIGS. 2 and 3, is utilized to capture video images of a user reciting text 430 while text 430 is displayed within text display window 420. Additionally, the captured video data is displayed within video display window 510, such as in real time during the user's recitation of text 430 and/or at a later time when the captured video data is subsequently reviewed.

Thus, second exemplary configuration 500 of interactive speech application 410 provides a means of enabling a user to see what he or she looks like when reciting a speech. This in turn enables the user to scrutinize his or her speaking skills to identify strengths and weaknesses in the user's recitation or deliverance of the speech. In this manner, second exemplary configuration 500 provides an interactive speech preparation and/or rehearsal system with video reviewing capability.

In an embodiment, interactive speech application 410 may include a number of video controls, which may be located within video display window 510, as shown, or alternatively outside of video display window 510. For example, interactive speech application 410 may include a record button 511, whereby a user, by clicking on record button 511, can cause a video data capturing device associated with interactive speech application 410 to capture video data of the user reciting a speech. Moreover, interactive speech application 410 may include a stop button 512, whereby a user, by clicking on stop button 512, can cause the video data capturing device to stop capturing video data. In this manner, the user is able to manually begin and stop recording of the video images.

In one embodiment, interactive speech application 410 includes a review button 513, whereby a user, by clicking on review button 513, can cause interactive speech application 410 to access captured video data and display said data within video display area 520 of video display window 510. This enables the user to subsequently review the captured video images after the user has finished reciting a speech, at the user's leisure. Moreover, interactive speech application 410 may also include a save button 514, whereby a user, by clicking on save button 514, can cause interactive speech application 410 to save a copy of the captured video data in a local or external storage device.

It is noted that interactive speech application 410 may include a number of additional displays for communicating information to a user that pertains to the video data and/or to a specific recording session. For example, and in accordance with an embodiment, interactive speech application 410 includes a status indicator 515 configured to display a status of a video display within video display window 510. To illustrate, and with reference to the embodiment shown in FIG. 5, video display window 510 is currently in a “STOPPED” status, as indicated by status indicator 515. As such, consecutive video images are not currently displayed within video display window 510. However, once interactive speech application 410 begins displaying consecutive video images within video display window 510, such as when a user clicks on review button 513, status indicator 515 will indicate that captured video images are currently “PLAYING” within video display window 510.

With reference still to FIG. 5, video display window 510 includes a time remaining indicator 516 configured to display an amount of time remaining for a recording session. Consider the example where a period of 30 minutes is selected for a particular recording session. Time remaining indicator 516 initially displays “30:00”, but this number is subsequently incremented down once the recording session has begun to thereby communicate to the user how much time is left for the session.

The foregoing notwithstanding, in one embodiment, the time allotted for a particular recording session may be selected or changed by a user. Consider the example where a user may click on time remaining indicator 516 and manually select or change the amount of time allocated to a particular recording session. Alternatively, or in addition to the foregoing, other methods of selecting or changing the time allotment may also be implemented.

The foregoing notwithstanding, and in accordance with an embodiment, video display window 510 includes a time lapsed indicator 517 configured to display an amount of time that has already lapsed for a particular recording session. For example, if a period of 30 minutes is selected for a particular recording session, time lapsed indicator 517 initially displays “00:00”, but this number is subsequently incremented up once the recording session has begun to thereby communicate to the user how much time has lapsed since the beginning of the session.

Finally, in an embodiment, video display window 510 includes a video display selector 518, whereby a user can select whether video data is to be displayed within video display window 510 when said video data is captured. For example, when a user clicks on a selector box 519 within video display selector 518, such that a check mark (“√”) appears therein, video images will not be displayed within video display window 510 during a recording session. Alternatively, if a check mark does not appear within selector box 519, video data will be displayed in real time within video display window 510 when said data is captured during the recording session.

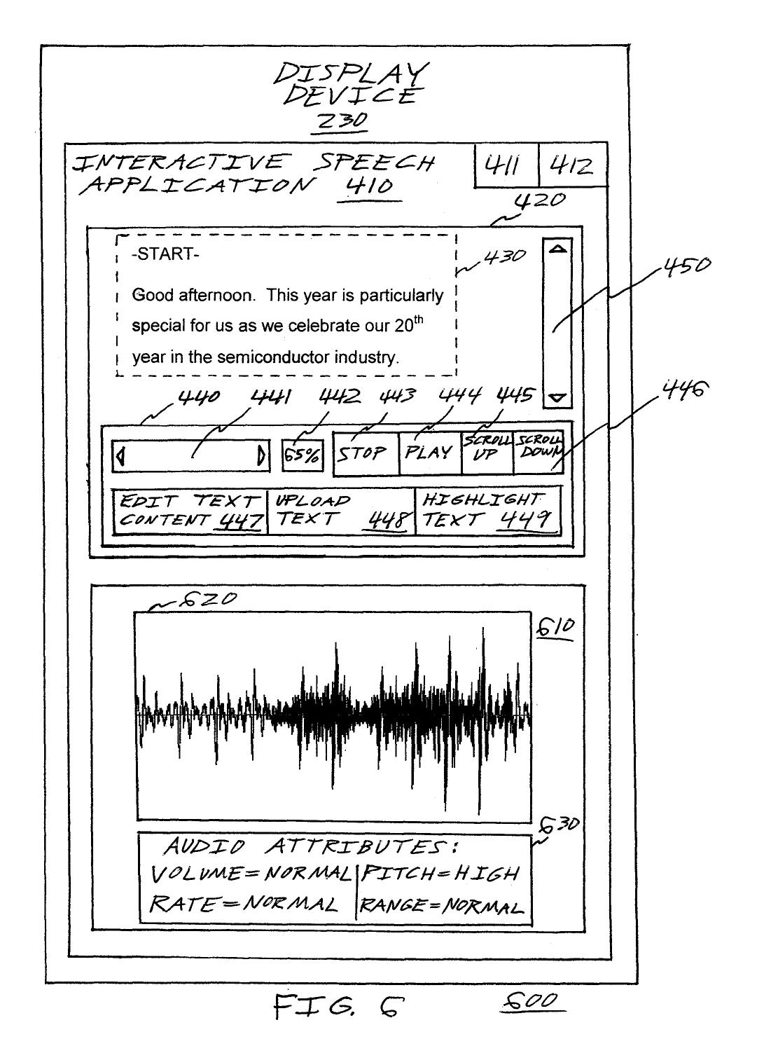

With reference now to FIG. 6, a third exemplary configuration 600 of interactive speech application 410 in accordance with an embodiment is shown. In particular, interactive speech application 410, which is displayed by display device 230, includes text display window 420 as well as an audio analysis display window 610. Audio analysis display window 610 is configured to display an audio analysis of captured audio data within an audio analysis display area 620 of audio analysis display window 610, such as an audio recording of a user who is currently or has recently recited text displayed in text display window 420.

Consider the example where an audio data capturing device, such as audio data capturing device 250 shown in FIGS. 2 and 3, is utilized to record the voice of a user who is reading text 430 when text 430 is displayed in text display window 420. Interactive speech application 410 analyzes the captured audio data and generates a technical audio analysis. This audio analysis is then displayed within audio analysis display window 610, and may be configured to offer the user feedback on, for example, the volume, rate, pitch, range, etc., of the user's voice. Indeed, a list of audio attributes 630 may be included to help communicate this information, as shown in FIG. 6. In this manner, interactive speech application 410 may be implemented so as to provide a user with constructive feedback on the user's audible recitation of a particular speech.

To further illustrate, an example provides that interactive speech application 410 accesses a sound frequency associated with the audio data, such as the frequency of the captured audio data within a specific period of time. Interactive speech application 410 then conducts a comparison of the sound frequency with a preselected frequency range, and if the sound frequency falls outside of this range, interactive speech application 410 concludes that the pitch of the user's voice is not within an acceptable range. Finally, interactive speech application 410 generates an audio analysis based on the comparison, such as to offer the user constructive feedback or criticism regarding the pitch of the user's voice. For purposes of illustration, list of audio attributes 630 shown in FIG. 6 identifies the pitch of an analyzed portion of audio data to be higher than normal. As a result, the user is put on notice that a potential problem exists with the user's audible recitation of text 430, at which point the user has the option of subsequently working to correct or alleviate this problem during subsequent speech rehearsals.

Moreover, in an embodiment, interactive speech application 410 compares the captured audio data and text 430 to generate an audio analysis reflecting a level of speech proficiency. Interactive speech application 410 then displays the audio analysis within audio analysis display window 610. To illustrate, an example provides that interactive speech application 410 is integrated with voice recognition functionality, whereby interactive speech application 410 is capable of analyzing the captured audio data and comparing the analyzed data to the words within text 430 to determine how many recognizable pronunciation errors are present in the captured audio data. Subsequently, the audio analysis is displayed to the user within audio analysis display window 610 so as to offer the user constructive feedback or criticism regarding the user's pronunciation of the terms at issue. As a result, interactive speech application 410 is able to bring a potential problem with the user's performance to the user's attention such that the user can subsequently work to correct the problem during subsequent speech rehearsals.

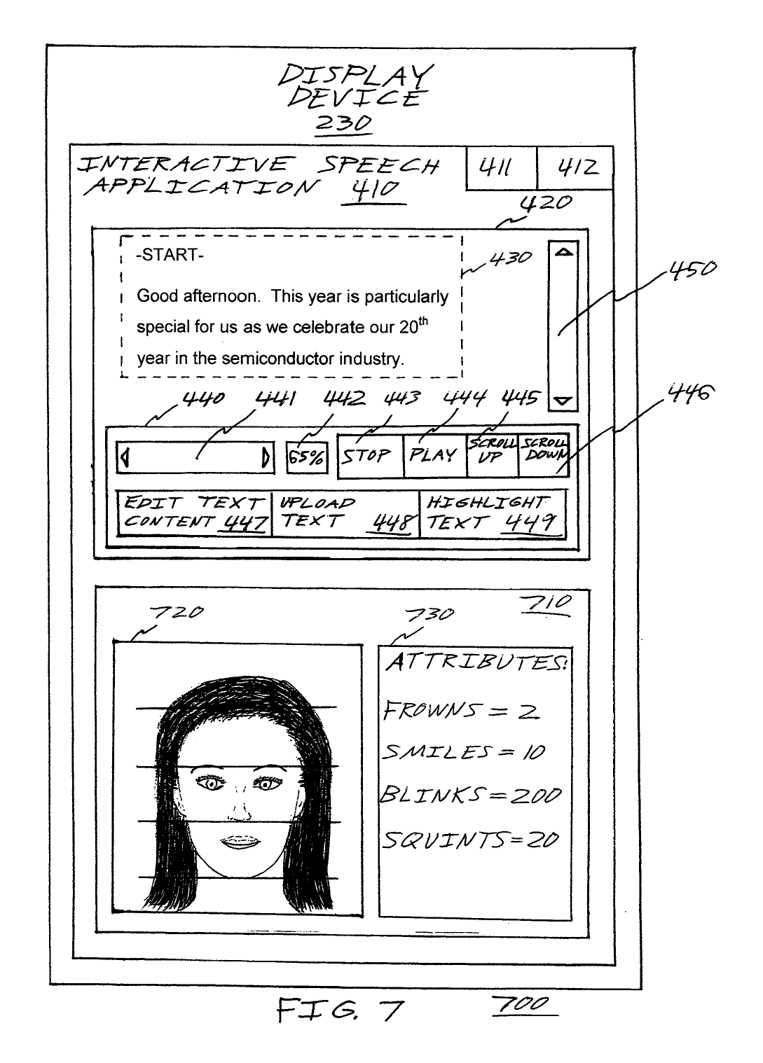

With reference now to FIG. 7, a fourth exemplary configuration 700 of interactive speech application 410 in accordance with an embodiment is shown. In particular, interactive speech application 410, which is displayed by display device 230, includes text display window 420 as well as a video analysis display window 710. Video analysis display window 710 is configured to display a video analysis associated with the captured video data, wherein the video analysis may include, for example, a facial feature analysis grid 720 and/or listing 730.

To illustrate, an example provides that images of a user's face are captured when the user is reciting a speech displayed in text display window 420. These images are then analyzed by facial analysis software associated or integrated with interactive speech application 410. When one or more positive and/or negative attributes are identified within a particular image by the facial analysis software, the image is flagged, and the identified positive or negative attributes, which may include, for example, frowns, smiles, blinks, squints, etc., are counted. Finally, a video analysis is displayed within video analysis display window 710, wherein one of the flagged images are displayed within facial feature analysis grid 720, and wherein information pertaining to the identified positive and/or negative attributes are listed within listing 730. Thus, an embodiment provides that interactive speech application 410 is configured to identify a facial expression or feature associated with the captured video data, and then generate a video analysis based on the identified facial expression or feature.

The foregoing notwithstanding, in an embodiment, interactive speech application 410 is configured, such as in response to a user selection, to automatically send or forward the captured video and audio data to an external database such that the captured data is stored remotely. Consider the example where video and audio data of a user reciting a displayed speech is captured, and then interactive speech application 410 automatically sends or uploads the captured data to a remote location where it may be accessed and scrutinized by a speech trainer. The trainer may then review the recorded data, and provide the user with advice as to how the user might improve his or her future speech performances. In this manner, interactive speech application 410 may be implemented with an automatic coaching feature. Furthermore, pursuant to one embodiment, interactive speech application 410 may be configured to display video tutorial information pertaining to effective speaking, such as in video display window 510.

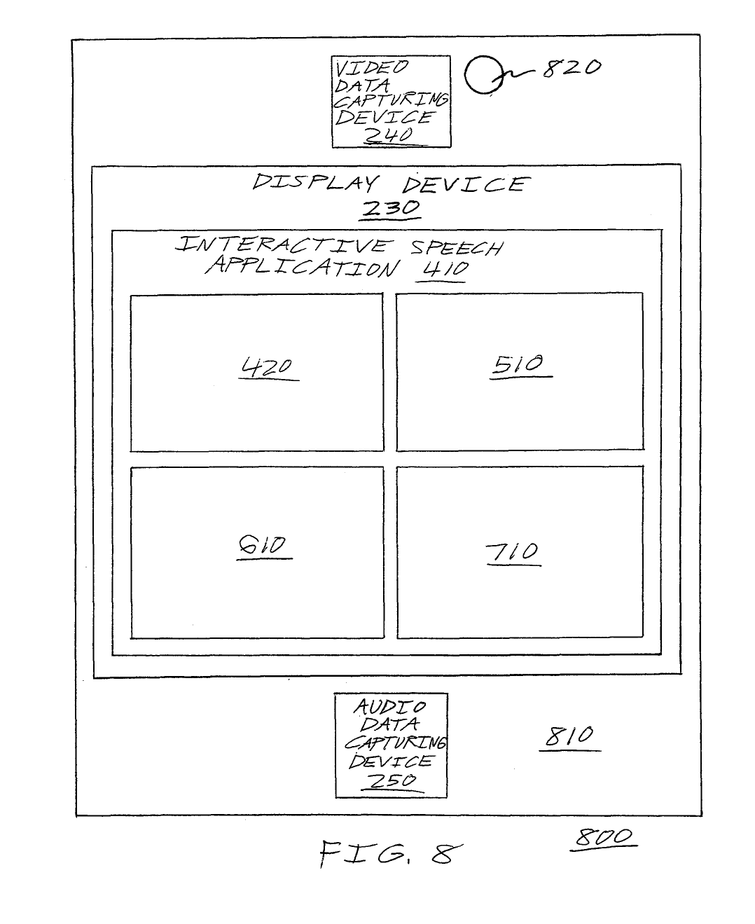

With reference now to FIG. 8, a fifth exemplary configuration 800 of interactive speech application 410 in accordance with an embodiment is shown. In particular, interactive speech application 410, which is displayed by display device 230, includes each of text and video display windows 420, 510 as well as audio and video analysis display windows 610, 710. In one embodiment, each of these windows is displayed within a single page of the graphical user interface such that the user is not forced to toggle between different pages of interactive speech application 410 to access the various windows.

The foregoing notwithstanding, the present technology is not limited to the simultaneous display of text and video display windows 420, 510 as well as audio and video analysis display windows 610, 710. Rather, interactive speech application 410 may be configured to include one or more these windows, and/or two or more of these windows may be displayed at different times rather than simultaneously.

With reference still to FIG. 8, it is noted that display device 230 is coupled with, or embedded within, a housing 810. Additionally, video and audio data capturing devices 240, 250, such as described above with respect to FIG. 2, are coupled with, or embedded within, housing 810. In one embodiment, video data capturing device 240 and/or audio data capturing device 250 are positioned on a same side of housing 810 as display device 230. In this manner, video data capturing device 240 and audio data capturing device 250 may be positioned so as to be “front-mounted” devices, such as to increase the ability of these devices to capture audio and video data of interest when a user is viewing text displayed within text display window 420.

Furthermore, in an embodiment, a display element 820 may optionally be coupled with, or embedded within, housing 810, wherein display element 820 is positioned so as to help bring a user's attention to video data capturing device 240. Consider the example where display element 820 is an illuminating device such as a LED. When a recording session begins, display element 820 blinks or flashes so as to remind a user to periodically glance from text display window 420 to video data capturing device 240. In so much as video data capturing device 240 functions to capture video images of the user reciting a displayed speech, video data capturing device 240 also serves as a virtual audience, thus causing periodic eye contact with video data capturing device 240 to be beneficial to a speech rehearsal or training session. As such, display element 820 may be implemented to help a user to develop better eye contact with an audience over time.

### Exemplary Methodologies

In an embodiment, a computer readable medium stores a set of instructions that when executed cause a computer to perform a method of interactive speech preparation. As such, various exemplary methods of speech preparation will now be discussed. However, the present technology is not limited to these exemplary methods.

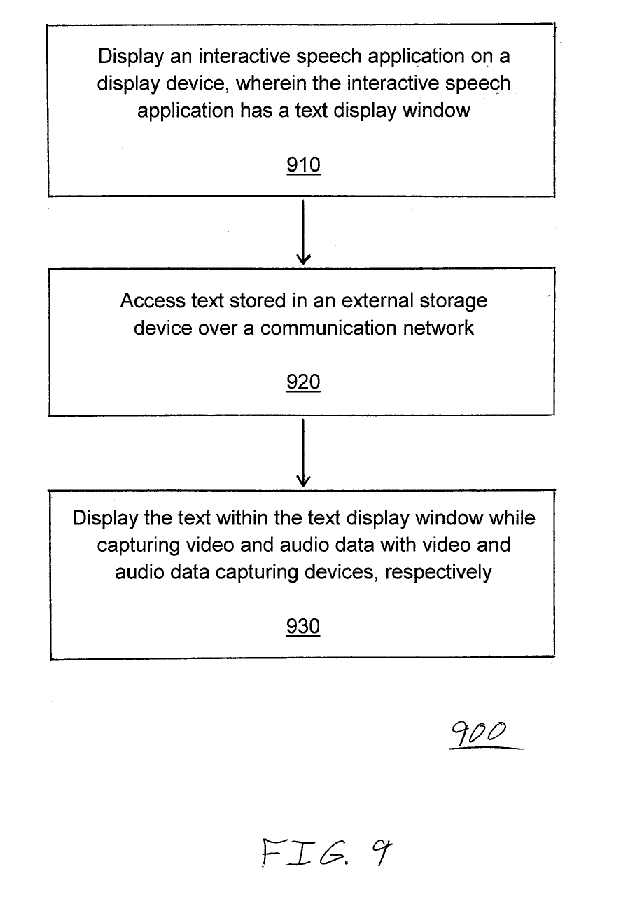

With reference now to FIG. 9, a first exemplary method 900 of interactive speech preparation in accordance with an embodiment is shown. First exemplary method 900 includes displaying an interactive speech application on a display device, wherein the interactive speech application has a text display window 910, accessing text stored in an external storage device over a communication network 920, and displaying the text within the text display window while capturing video and audio data with video and audio data capturing devices, respectively 930. To illustrate, an example provides that first exemplary method 900 is implemented to display text to a user while simultaneously capturing video and audio data of the user reciting the displayed text. The user may then review the captured data to assess the strengths and weaknesses of his or her performance.

The foregoing notwithstanding, it is noted that first exemplary method 900 includes accessing text stored in an external storage device over a communication network 920. However, the present technology is not limited to accessing text stored in an external storage device. For example, an embodiment provides that the text is instead accessed from a local storage device before being displayed.

Additionally, it is noted that first exemplary method 900 may be modified such that audio data is not captured. For example, in the event that the user is deaf or hearing impaired, and is delivering a displayed speech using sign language, capturing ambient background audio might not be helpful to the subsequent performance review process.

Moreover, first exemplary method 900 may also be further expanded. To illustrate, an embodiment provides that first exemplary method 900 includes downloading the interactive speech application to a local storage device from an external storage device. Consider the example where the interactive speech application includes a set of computer readable instructions stored in a remote database. The remotely stored instructions for the interactive speech application are downloaded, such as over the Internet or a cellular network, to a local storage device, such as a magnetic or electronic data storage unit integrated with a handheld computing device. Once the interactive speech application has been downloaded, the application may be launched locally, such as on the handheld device.

Furthermore, in one embodiment, first exemplary method 900 includes accessing text stored in a local memory device, such as a magnetic or electronic data storage unit integrated with a handheld computing device. First exemplary method 900 further includes sending the text to an external storage device such that the text is stored at a remote location. In this manner, although interactive speech application may be launched locally, a user may store a number of speeches in a remote database so as to free up space in local memory. Subsequently, the user may access the remotely stored text to display the text locally during a recording session.

Various methodologies for displaying data to a user may be implemented. In an embodiment, first exemplary method 900 includes simultaneously displaying the text display window and a video display window within the interactive speech application, and displaying in real time the video data within the video display window while the video data is captured with the video data capturing device. In this manner, first exemplary method 900 may be implemented, for example, so as to display video images of a user reciting a displayed speech at the same time that the user is reciting the speech. This will provide the user with the opportunity of making adjustments to his or her deliverance of the speech on the fly based on various strengths and/or weaknesses in the performance or deliverance that are reflected in the displayed video images.

In one embodiment, however, the video data is not displayed in real time while it is being captured. It is noted that, in certain instances, a user may find the display of the captured video images to be distracting when the user is still reciting a displayed speech. For example, the displayed video images may distract the user's eyes from focusing on the text that is to be recited. As such, an embodiment provides that first exemplary method 900 includes simultaneously displaying the text display window and a video display window within the interactive speech application, prompting a user for a video display selection, and, in response to the video display selection, enabling or preventing a display, in real time, of the video data within the video display window while the video data is captured with the video data capturing device. In view of the foregoing, first exemplary method 900 may be implemented so as to provide a user with the option of either displaying or “hiding” the captured video data when the user is still reciting a displayed speech.

Moreover, and in accordance with an embodiment, first exemplary method 900 includes storing the video and audio data in a local storage device in response to a user input, such as when a user chooses to store the data for a particular recording session. First exemplary method 900 also includes accessing the video and audio data in the local storage device in response to a user selection, such as when a user subsequently chooses to review the stored data. First exemplary method 900 further includes displaying a video display window within the interactive speech application, and displaying the video data within the video display window while outputting the audio data with an audio output device. In this manner, the stored data may be output to a user so that the data may be manually analyzed or scrutinized at a point in time subsequent to being captured.

Pursuant to one embodiment, however, first exemplary method 900 includes automatically storing the captured video and audio data in an external database, and accessing a performance analysis associated with the video and audio data. Consider the example where video and audio data of a user reciting a displayed speech is captured, and then the interactive speech application automatically sends or uploads the captured data to a remote location where it may be accessed and scrutinized by a speech trainer. The trainer may then review the recorded data, and provide the user with a performance analysis that includes advice as to how the user might improve his or her future speech performances. Alternatively, or in addition to the foregoing, the captured data may be analyzed at a remote location, such as by video and audio analysis software, and a performance analysis that critiques the recorded performance may be generated and forwarded to the speaker, such as in an e-mail or in a display window of the interactive speech application.

Furthermore, an embodiment provides that the displayed text is moved, such as vertically or horizontally, through the text display window. For example, first exemplary method 900 may be expanded to include moving the text within the text display window based on a preselected scrolling speed. This preselected scrolling speed may be based on a known or assessed user reading speed. In this manner, the text will move within a display screen at a comfortable speed for a user such that the user can recite the displayed text without manually scrolling through the text.

It is noted that the interactive speech application may be integrated with voice recognition capabilities, such as to analyze a voice recording captured during a recording session. In one embodiment, first exemplary method 900 includes analyzing the audio data in real time while the audio data is captured to identify two words associated with both of the text and the audio data, calculating a relationship between the two words within the text, selecting a scrolling speed based on the relationship, and moving the text within the text display window based on the scrolling speed.

For example, if the same two words are identified within both the displayed text and the captured audio data, a temporal relationship between the two words in the audio data is calculated to determine how fast a user is speaking. Next, a scrolling speed is selected based on a natural speaking speed associated with the audio data. In this manner, the application's scrolling speed may be automatically adjusted on the fly based on the speed with which a user naturally speaks.

The foregoing notwithstanding, in an embodiment, first exemplary method 900 includes accessing a preselected word, syllable or sound, such as from a knowledge database, and analyzing the audio data to count a number of occurrences of the preselected word, syllable or sound within the audio data. This number of occurrences is then displayed within the interactive speech application. For example, the number of times that a user utters the term “Um” during a sound recording may be counted and then displayed to the user. In so much as the use of the term “Um” is generally frowned upon with regard to speech delivery, the user may wish to continue rehearsing a particular speech so as to practice avoiding the recitation of this particular term.

First exemplary method 900 may also be expanded such that the captured data is forwarded to one or more remote electronic devices. To illustrate, and in accordance with an embodiment, first exemplary method 900 includes initiating a video conference between the interactive speech application and a remote electronic device. First exemplary method 900 further includes sending the video and audio data in real time to the remote electronic device while the video and audio data is respectively captured with the video and audio data capturing devices. In the event that the video conference is conducted between, for example, two cellular telephones with video conferencing capabilities, a recording session may be viewed remotely by another individual such that the remote viewer can provide the speaker with immediate feedback on the speaker's performance.

It is noted that an audio analysis of the audio data captured during a recording session may be generated. Indeed, an embodiment provides that first exemplary method 900 includes displaying an audio analysis display window within the interactive speech application, analyzing the audio data to generate an audio analysis, and displaying the audio analysis within the audio analysis display window. First exemplary method 900 may also include accessing a sound frequency associated with the audio data, conducting a comparison of the sound frequency with a preselected frequency range, and generating the audio analysis based on the comparison.

To illustrate, an example provides that a sound frequency associated with the captured audio data is accessed. A comparison is then conducted between the sound frequency and a preselected frequency range. If the sound frequency falls outside of the preselected frequency range, the pitch of the user's voice is identified as not being within acceptable limits. Finally, an audio analysis is generated based on the comparison, such as to offer constructive feedback or criticism regarding the pitch of a speaker's voice. As a result, the speaker is put on notice that a potential problem exists, and can subsequently work to correct the problem during subsequent speech rehearsals.

The foregoing notwithstanding, in an embodiment, first exemplary method 900 includes displaying an audio analysis display window within the interactive speech application, comparing the audio data and the text to generate an audio analysis reflecting a level of speech proficiency, and displaying the audio analysis within the audio analysis display window. To illustrate, consider the example where the interactive speech application is integrated with voice recognition functionality, whereby the interactive speech application is capable of analyzing the captured audio data and comparing the analyzed data to the words within the displayed text to determine how many recognizable pronunciation errors are present in the captured audio data. Subsequently, the audio analysis is displayed within an audio analysis display window so as to offer constructive feedback or criticism regarding the speaker's pronunciation of the terms at issue. As a result, a potential problem with the speaker's performance may be brought to the speaker's attention such that the speaker can subsequently work to correct the problem during subsequent speech rehearsals.

Furthermore, it is noted that a video analysis may be performed, such as to provide a user with feedback regarding a visual aspect of the user's performance. To illustrate, an embodiment provides that first exemplary method 900 includes displaying a video analysis display window within the interactive speech application, analyzing the video data to generate a video analysis, and displaying the video analysis within the video analysis display window. With respect to the generation of the video analysis, first exemplary method 900 may also include identifying a facial expression or feature associated with the video data, and generating the video analysis based on the identification of the facial expression or feature.

To further illustrate, an example provides that images of a user's face are captured when the user is reciting a speech displayed in the text display window. These images are then analyzed, and one or more positive and/or negative attributes are identified within a particular image. As a result, the image is flagged, and the identified positive or negative attributes, which may include, for example, frowns, smiles, blinks, squints, etc., are counted. Finally, a video analysis is displayed within a video analysis display window, wherein the video analysis may include information pertaining to the identified positive and/or negative attributes, such as the number of instances that each attribute was identified within the various video images. Thus, an embodiment provides that a facial expression or feature associated with the captured video data is identified, and a video analysis is generated based on the identified facial expression or feature.

Additionally, an embodiment provides that a video analysis is generated based on a user's body language, as reflected in the captured video data. Consider the example where a user is deaf or hearing impaired, and is delivering a displayed speech using sign language. The physical gestures identified in the captured video images are compared to a number of gestures in a knowledge database, and a video analysis is generated that critiques the clarity of the user's gestures.

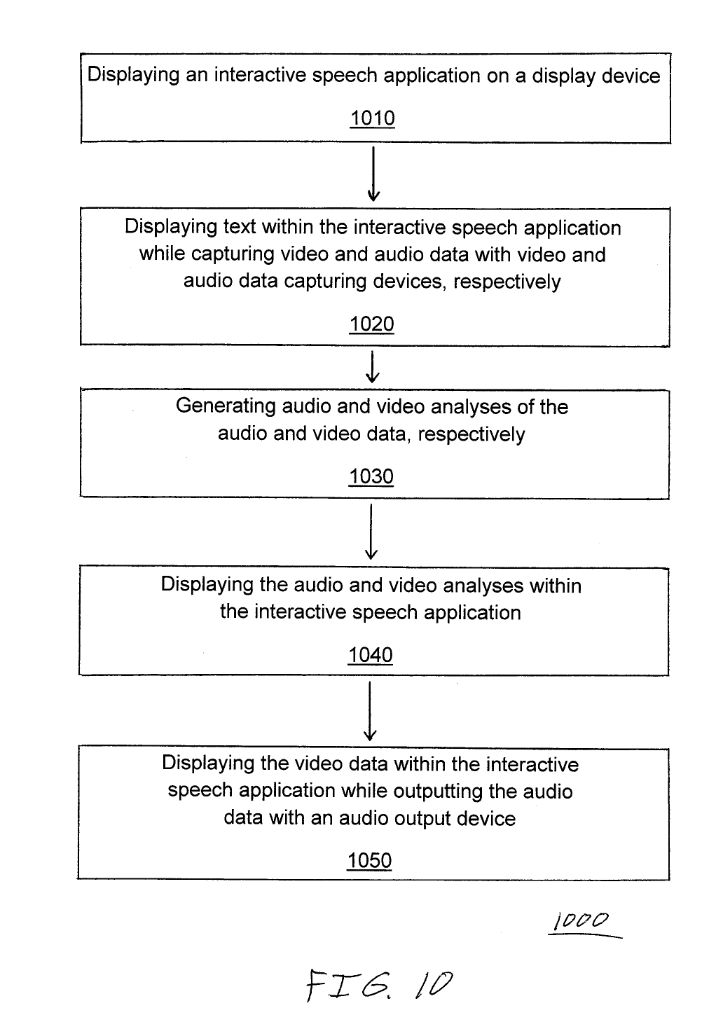

With reference now to FIG. 10, a second exemplary method 1000 of interactive speech preparation in accordance with an embodiment is shown. Second exemplary method 1000 includes displaying an interactive speech application on a display device 1010, displaying text within the interactive speech application while capturing video and audio data with video and audio data capturing devices, respectively 1020, generating audio and video analyses of the audio and video data, respectively 1030, displaying the audio and video analyses within the interactive speech application 1040, and displaying the video data within the interactive speech application while outputting the audio data with an audio output device 1050. Thus, second exemplary method 1000 represents a relatively comprehensive method of interactive speech preparation, whereby the captured audio and video data, as well as analyses thereof, may be output to a user.

It is noted that various types of audio and video analyses may be implemented, and that the present technology is not limited to any particular types of analysis. To illustrate, an embodiment provides that second exemplary method 1000 includes comparing the audio data and the text to generate the audio analysis, wherein the audio analysis reflects a level of speech proficiency. Consider the example where the captured audio data is analyzed to identify a number of spoken words, and these identified words are compared to the words within the displayed text to determine how many recognizable pronunciation errors are present in the captured audio data. An audio analysis is then generated to list the identified errors.

Moreover, in one embodiment, second exemplary method 1000 includes accessing a sound frequency associated with the captured audio data, conducting a comparison of the sound frequency with a preselected frequency range, and generating an audio analysis based on the comparison. Consider the example where the sound frequency is identified as falling outside of the preselected frequency range as a result of a comparison that is conducted between the sound frequency and a preselected frequency range. An audio analysis is generated based on the comparison, such as to alert a speaker to a potential problem with the pitch of the speaker's voice.

Furthermore, and in accordance with an embodiment, second exemplary method 1000 includes identifying a facial expression or feature associated with the video data, such as by accessing known facial expressions or features in a knowledge database, and comparing the known facial expressions or features to those identified within a captured video image. Second exemplary method 1000 also includes generating a video analysis based on the identification of the facial expression or feature. For example, in the event that it is determined that a captured image of a speaker includes a frown, the image will be flagged, and a video analysis is generated to alert the speaker that a potential problem exists with the speaker's facial expressions.

### Summary Concepts

It is noted that the foregoing discussion has presented at least the following concepts:
Concept 0. A computer readable medium storing a set of instructions that when executed cause a computer to perform a method of interactive speech preparation, the method including or comprising:

displaying text while capturing video and audio data.
Concept 1. A computer readable medium storing a set of instructions that when executed cause a computer to perform a method of interactive speech preparation, the method including or comprising:

displaying an interactive speech application on a display device, the interactive speech application having a text display window;

accessing text stored in an external storage device over a communication network; and

displaying the text within the text display window while capturing video and audio data with video and audio data capturing devices, respectively.
Concept 2. The computer readable medium of Concept 1, wherein the method further includes or comprises:

simultaneously displaying the text display window and a video display window within the interactive speech application; and

displaying, in real time, the video data within the video display window while the video data is captured with the video data capturing device.
Concept 3. The computer readable medium of Concept 1, wherein the method further includes or comprises:

simultaneously displaying the text display window and a video display window within the interactive speech application;

prompting a user for a video display selection; and

in response to the video display selection, enabling or preventing a display, in real time, of the video data within the video display window while the video data is captured with the video data capturing device.
Concept 4. The computer readable medium of Concept 1, wherein the method further includes or comprises:

storing the video and audio data in a local storage device in response to a user input;

accessing the video and audio data in the local storage device in response to a user selection;

displaying a video display window within the interactive speech application; and

displaying the video data within the video display window while outputting the audio data with an audio output device.
Concept 5. The computer readable medium of Concept 1, wherein the method further includes or comprises:

automatically storing the video and audio data in an external database; and

accessing a performance analysis associated with the video and audio data.
Concept 6. The computer readable medium of Concept 1, wherein the method further includes or comprises:

downloading the interactive speech application to a local storage device from the external storage device;

accessing text stored in a local memory device; and

sending the text to the external storage device such that the text is stored in the external storage device.
Concept 7. The computer readable medium of Concept 1, wherein the method further includes or comprises:

moving the text within the text display window based on a preselected speed.
Concept 8. The computer readable medium of Concept 1, wherein the method further includes or comprises:

analyzing the audio data in real time while the audio data is captured to identify two words associated with both of the text and the audio data;

calculating a relationship between the two words within the text;

selecting a scrolling speed based on the relationship; and

moving the text within the text display window based on the scrolling speed.
Concept 9. The computer readable medium of Concept 1, wherein the method further includes or comprises:

accessing a preselected word, syllable or sound;

analyzing the audio data to count a number of occurrences of the preselected word, syllable or sound within the audio data; and

displaying the number of occurrences within the interactive speech application.
Concept 10. The computer readable medium of Concept 1, wherein the method further includes or comprises:

initiating a video conference between the interactive speech application and a remote electronic device; and

sending, in real time, the video and audio data to the remote electronic device while the video and audio data is respectively captured with the video and audio data capturing devices.
Concept 11. The computer readable medium of Concept 1, wherein the method further includes or comprises:

displaying an audio analysis display window within the interactive speech application;

analyzing the audio data to generate an audio analysis; and

displaying the audio analysis within the audio analysis display window.
Concept 12. The computer readable medium of Concept 11, wherein the method further includes or comprises:

accessing a sound frequency associated with the audio data;

conducting a comparison of the sound frequency with a preselected frequency range; and

generating the audio analysis based on the comparison.
Concept 13. The computer readable medium of Concept 1, wherein the method further includes or comprises:

displaying an audio analysis display window within the interactive speech application;

comparing the audio data and the text to generate an audio analysis reflecting a level of speech proficiency; and

displaying the audio analysis within the audio analysis display window.
Concept 14. The computer readable medium of Concept 1, wherein the method further includes or comprises:

displaying a video analysis display window within the interactive speech application;

analyzing the video data to generate a video analysis; and

displaying the video analysis within the video analysis display window.
Concept 15. The computer readable medium of Concept 14, wherein the method further includes or comprises:

identifying a facial feature associated with the video data; and

generating the video analysis based on the identifying of the facial feature.
Concept 16. An interactive speech preparation system including or comprising:

a bus;

a processor associated with the bus;

a display device associated with the bus;

video and audio data capturing devices associated with the bus; and

a local storage device associated with the bus and storing a set of instructions that when executed:
cause the processor to access text stored in an external storage device over a communication network;
cause the display device to display an interactive speech application having a text display window, and to further display the text within the text display window; and
cause the video and audio data capturing devices to capture video and audio data, respectively, when the text is displayed within the text display window.
Concept 17. The interactive speech system of Concept 16, further including or comprising:

an audio output device associated with the bus, wherein the set of instructions when executed:
cause the display device to display a video display window within the interactive speech application;
cause the display device to display the video data within the video display window; and
cause the audio output device to output the audio data when the video data is displayed within the video display window.
Concept 18. The interactive speech system of Concept 16, further including or comprising:

a router associated with the bus; and

a remote electronic device configured to communicate with the router over a communication network;

wherein the set of instructions when executed:
cause the router to initiate a video conference between the interactive speech application and the remote electronic device; and
cause the router to send, in real time, the video and audio data to the remote electronic device while the video and audio data is respectively captured with the video and audio data capturing devices.
Concept 19. A computer readable medium storing a set of instructions that when executed cause a computer to perform a method of interactive speech preparation, the method including or comprising:

displaying an interactive speech application on a display device;

displaying text within the interactive speech application while capturing video and audio data with video and audio data capturing devices, respectively;

generating audio and video analyses of the audio and video data, respectively;

displaying the audio and video analyses within the interactive speech application; and

displaying the video data within the interactive speech application while outputting the audio data with an audio output device.
Concept 20. The computer readable medium of Concept 19, wherein the method further includes or comprises:

comparing the audio data and the text to generate the audio analysis, the audio analysis reflecting a level of speech proficiency;

identifying a facial feature associated with the video data; and

generating the video analysis based on the identifying of the facial feature.

Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer readable medium storing a set of instructions that when executed cause a computer to perform a method of interactive speech preparation, said method comprising:
displaying an interactive speech application on a display device, said interactive speech application having a text display window;
accessing text stored in an external storage device over a communication network; and
displaying said text within said text display window while capturing video and audio data with video and audio data capturing devices, respectively.

2. The computer readable medium of claim 1, wherein said method further comprises:
simultaneously displaying said text display window and a video display window within said interactive speech application; and
displaying, in real time, said video data within said video display window while said video data is captured with said video data capturing device.

3. The computer readable medium of claim 1, wherein said method further comprises:
simultaneously displaying said text display window and a video display window within said interactive speech application;
prompting a user for a video display selection; and
in response to said video display selection, enabling or preventing a display, in real time, of said video data within said video display window while said video data is captured with said video data capturing device.

4. The computer readable medium of claim 1, wherein said method further comprises:
storing said video and audio data in a local storage device in response to a user input;
accessing said video and audio data in said local storage device in response to a user selection;
displaying a video display window within said interactive speech application; and
displaying said video data within said video display window while outputting said audio data with an audio output device.

5. The computer readable medium of claim 1, wherein said method further comprises:
automatically storing said video and audio data in an external database; and
accessing a performance analysis associated with said video and audio data.

6. The computer readable medium of claim 1, wherein said method further comprises:
downloading said interactive speech application to a local storage device from said external storage device;
accessing text stored in a local memory device; and
sending said text to said external storage device such that said text is stored in said external storage device.

7. The computer readable medium of claim 1, wherein said method further comprises:
moving said text within said text display window based on a preselected speed.

8. The computer readable medium of claim 1, wherein said method further comprises:
analyzing said audio data in real time while said audio data is captured to identify two words associated with both of said text and said audio data;
calculating a relationship between said two words within said text;
selecting a scrolling speed based on said relationship; and
moving said text within said text display window based on said scrolling speed.

9. The computer readable medium of claim 1, wherein said method further comprises:
accessing a preselected word, syllable or sound;
analyzing said audio data to count a number of occurrences of said preselected word, syllable or sound within said audio data; and
displaying said number of occurrences within said interactive speech application.

10. The computer readable medium of claim 1, wherein said method further comprises:
initiating a video conference between said interactive speech application and a remote electronic device; and
sending, in real time, said video and audio data to said remote electronic device while said video and audio data is respectively captured with said video and audio data capturing devices.

11. The computer readable medium of claim 1, wherein said method further comprises:
displaying an audio analysis display window within said interactive speech application;
analyzing said audio data to generate an audio analysis; and
displaying said audio analysis within said audio analysis display window.

12. The computer readable medium of claim 11, wherein said method further comprises:
accessing a sound frequency associated with said audio data;
conducting a comparison of said sound frequency with a preselected frequency range; and
generating said audio analysis based on said comparison.

13. The computer readable medium of claim 1, wherein said method further comprises:
displaying an audio analysis display window within said interactive speech application;
comparing said audio data and said text to generate an audio analysis reflecting a level of speech proficiency; and
displaying said audio analysis within said audio analysis display window.

14. The computer readable medium of claim 1, wherein said method further comprises:
displaying a video analysis display window within said interactive speech application;
analyzing said video data to generate a video analysis; and
displaying said video analysis within said video analysis display window.

15. The computer readable medium of claim 14, wherein said method further comprises:
identifying a facial feature associated with said video data; and
generating said video analysis based on said identifying of said facial feature.

16. An interactive speech preparation system comprising:
a bus;
a processor associated with said bus;
a display device associated with said bus;
video and audio data capturing devices associated with said bus; and
a local storage device associated with said bus and storing a set of instructions that when executed:
cause said processor to access text stored in an external storage device over a communication network;
cause said display device to display an interactive speech application having a text display window, and to further display said text within said text display window; and
cause said video and audio data capturing devices to capture video and audio data, respectively, when said text is displayed within said text display window.

17. The interactive speech system of claim 16, further comprising:
an audio output device associated with said bus, wherein said set of instructions when executed:
cause said display device to display a video display window within said interactive speech application;
cause said display device to display said video data within said video display window; and
cause said audio output device to output said audio data when said video data is displayed within said video display window.

18. The interactive speech system of claim 16, further comprising:
a router associated with said bus; and
a remote electronic device configured to communicate with said router over a communication network;
wherein said set of instructions when executed:
cause said router to initiate a video conference between said interactive speech application and said remote electronic device; and
cause said router to send, in real time, said video and audio data to said remote electronic device while said video and audio data is respectively captured with said video and audio data capturing devices.

19. A computer readable medium storing a set of instructions that when executed cause a computer to perform a method of interactive speech preparation, said method comprising:
displaying an interactive speech application on a display device;
displaying text within said interactive speech application while capturing video and audio data with video and audio data capturing devices, respectively;
generating audio and video analyses of said audio and video data, respectively;
displaying said audio and video analyses within said interactive speech application; and
displaying said video data within said interactive speech application while outputting said audio data with an audio output device.

20. The computer readable medium of claim 19, wherein said method further comprises:
comparing said audio data and said text to generate said audio analysis, said audio analysis reflecting a level of speech proficiency;
identifying a facial feature associated with said video data; and
generating said video analysis based on said identifying of said facial feature.
